(19) United States
(12) Patent Application Publication
(10) Pub. No.: US 2026/0249726 A1
(43) Pub. Date: Aug. 27, 2026

(54) FAST CHARGING SYSTEM USING COMPACT POWER GENERATION

(71) Applicant: Honeywell International Inc., Charlotte, NC (US)

(72) Inventor: Cristian E. Anghel, Tucson, AZ (US)

(73) Assignee: Honeywell International Inc., Charlotte, NC (US)

(21) Appl. No.: 19/060,382

(22) Filed: Feb. 21, 2025

(51) Int. Cl. H02J 7/14; B60L 53/22; B60L 53/57; B60L 53/62; H02J 7/24

(52) U.S. Cl. CPC B60L 53/57; B60L 53/11; B60L 53/62; B60L 53/53; B60L 2210/30; H02J 7/1415

(57) ABSTRACT

A charging system comprises a prime mover, a gear box coupled to the prime mover, and at least one generator coupled to the gear box. The generator is configured to produce an AC output with a frequency of at least about 300 Hz. At least one power converter is coupled to the generator, the power converter configured to convert the AC output to a HVDC power output of at least about 50 kW. A generator control unit is coupled to the generator and the power converter. The generator control unit selectively regulates a voltage of the HVDC power output from the power converter, in one of a plurality of modes; and selectively regulates a power of the power converter, in another of the modes. At least one interface is configured to be coupled to provide the HVDC power, output from the power converter, to a battery of electric vehicle.

### BACKGROUND

A plug-in hybrid electric vehicle (PHEV) requires a power electronic system between the power grid and the high voltage battery pack located inside the vehicle. This power electronic system is split into two parts: a charging station, which is also called electric vehicle service equipment (EVSE) or an off-board charger, and an onboard charger inside the vehicle. A charging station is part of the grid infrastructure installed along a street, parking lot, or in a home garage. The primary purpose of the charging station is to supply the power to the PHEV for charging the battery. The onboard charger is responsible for the final stage of charging the battery pack inside the vehicle. The onboard charger takes an alternating current (AC) power source from the EVSE and transforms the AC power into a required battery-charging profile.

In a conventional AC charging operation, AC power is supplied by the charging station to an onboard charger in the electric vehicle (EV), which converts the AC power into direct current (DC) power for charging the EV battery. Such AC charging operations take several hours to charge the EV battery. For example, a residential AC charging station can take up to about 17 hours to charge the EV battery. A commercial AC charging station can take up to about 8 hours to charge the EV battery.

In conventional fast charging systems, DC power is supplied directly to a vehicle battery, bypassing the onboard charger in the EV. For example, in a DC fast charging operation, AC power from the power grid is converted to DC power in a charging station, which then supplies the DC power directly to an EV battery. The fast charging operation can reduce the charging time to about 30 minutes.

In addition to traditional grid-connected charging stations, mobile charging stations have been developed as another source for charging electric vehicles. While these mobile charging stations have advantages over traditional grid-connected stations, the mobile charging stations have several disadvantages, including being large, heavy, technically complex, expensive, and having limited reliability.

### SUMMARY

A charging system comprises a prime mover, a gear box operatively coupled to the prime mover, and at least one generator operatively coupled to the gear box. The at least one generator is configured to produce an alternating current (AC) output with a frequency of at least about 300 Hz. At least one power converter is operatively coupled to the at least one generator, the at least one power converter configured to convert the AC output to a high voltage direct current (HVDC) power output of at least about 50 kW. A generator control unit is operatively coupled to the at least one generator and the at least one power converter. The generator control unit is configured to selectively regulate a voltage of the HVDC power output from the at least one power converter, in one of a plurality of modes; and selectively regulate a power of the at least one power converter, in another of the plurality of modes. At least one interface is configured to be coupled to provide the HVDC power, output from the at least one power converter, to a battery of at least one electric vehicle.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a mobile charging system for electric vehicle batteries, according to one embodiment;

FIG. 2 is a graph representing an operation of a mobile fast charging system, according to one example;

FIG. 3 is a schematic diagram of an electric power generator system for a mobile charging system for charging a battery of an electric vehicle, according to another embodiment;

FIG. 4 illustrates a fast charging system using compact power generation, according to one implementation;

FIG. 5 illustrates a fast charging system using compact power generation, according to another implementation;

FIG. 6 illustrates a 1,000 kW generator that can be used in a fast charging system;

FIG. 7 illustrates a 250 kW generator that can be used in a fast charging system;

FIG. 8 illustrates a high voltage DC generator control unit that can be used in a fast charging system; and

FIG. 9 illustrates an advanced rectifier filter unit that can be used in a fast charging system.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

Embodiments of fast charging systems that use compact power generation devices are described herein.

In one embodiment, a compact low-weight, mobile fast charger system is provided that can replace large and heavy 50/60 Hz diesel generators, and the AC/DC and DC/DC off-board level 3 charger, with a turbogenerator, where the prime mover is a turbine engine, driving a generator having a high voltage direct current (HVDC) power output. In an alternative embodiment, a high speed compact HVDC generator can be employed using diesel or other types of engines with a speed increaser gear box to produce a mobile fast charger system.

A compact fast charger using a high speed generator can also be combined with energy storage for increased capacity and silent operation. Alternately, a high speed compact HVDC generator can be employed using diesel or other types of engines. In these cases, a speed increaser gear box may be necessary.

The present mobile fast charger systems have various advantages over conventional fast charging systems, including less weight, smaller size, less expensive, and more dependable. The present mobile fast charger systems also provide a substantial reduction in charging time, making remote charging practical.

Further details of various embodiments are described hereafter and with reference to the drawings.

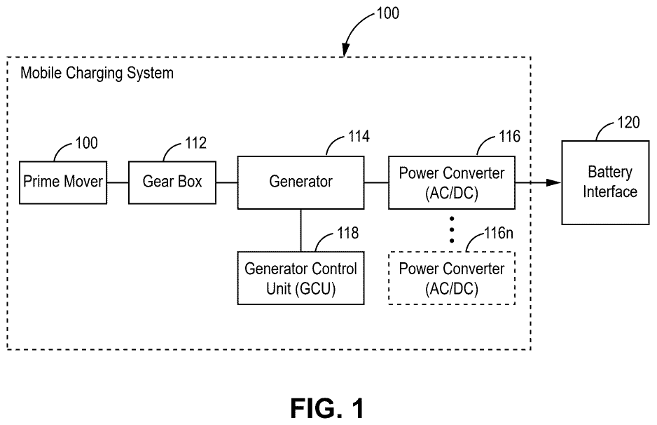

FIG. 1 illustrates a mobile charging system 100 for electric vehicle batteries, according to one embodiment. The charging system 100 comprises a prime mover 110, and a gear box 112 operatively coupled to the prime mover 110 such as through a drive shaft. The gear box 112 is configured to increase or decrease the speed of the drive shaft. A high voltage generator 114 is operatively coupled to the gear box 112 and produces an AC output with a frequency of at least about 300 Hz. For example, the generator 114 can be a 1,000 Kilowatt (kW) generator, or a 50 kW generator. The prime mover 110 provides the driving torque for the generator 114. For example, the prime mover 110 can be a turbine, a diesel engine, a Wankel engine, or some other type of engine or torque producing device.

At least one power converter 116 ( . . . 116n) is operatively coupled to the generator 114 and is configured to convert the AC output to a HVDC power of at least about 50 kW. For example, the power converter 116 can be an advanced rectifier filter unit (ARFU).

A generator control unit (GCU) 118 is operatively coupled to the high voltage generator 114 and the power converter 116. The generator control unit 118 is configured to selectively regulate the HVDC voltage at an output of the power converter 116 in a voltage control mode. The generator control unit 118 is also configured to selectively regulate the power of the power converter 116 in a power control mode. For example, the generator control unit 118 can be configured to selectively control the AC output of the generator 114 using AC voltage regulation and the HVDC output of the power converter 116 using DC voltage regulation. The generator control unit 118 can also be configured to selectively regulate the power of the power converter 116 based on a parameter of a battery of an electric vehicle. In one example implementation, the generator control unit 118 can be a HVDC generator control unit. The generator control unit 118 is configured to increase or decrease an excitation current to the generator 114.

In addition, a battery interface 120 is configured to be coupled to provide the HVDC power output from the power converter 116 to a battery of an electric vehicle.

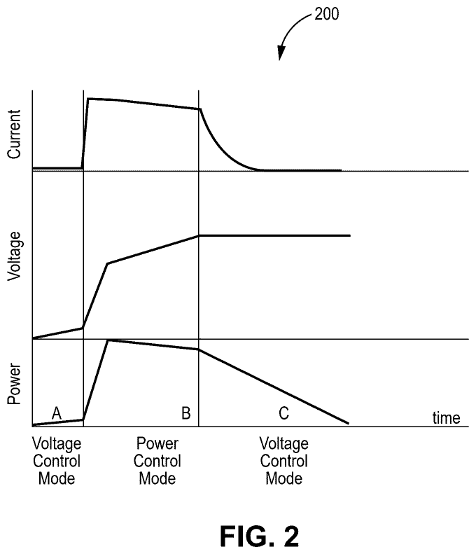

FIG. 2 is a graph 200 representing the operation of a mobile fast charging system using compact power generation, according to one example of the present approach. The graph 200 depicts power, voltage and current, with respect to a voltage control mode and a power control mode over time for zones A, B and C. It should be noted that the time axis is not to scale.

In zone A, the voltage control mode regulates a voltage of the charging system and determines the rate of charge. At the same time, the voltage of the charging system is adjusted to match a vehicle battery voltage, while the current and power are maintained at a minimum value.

In zone B, the power control mode regulates the power and current of the charging system to the maximum values allowed by the state of charge of the battery. Typically, the current is maintained at its maximum value while the voltage is increased, and the power is slowly decreased.

In zone C, the voltage control mode regulates the voltage of the charging system such that the charging slows down to protect the battery. Zone C typically starts after the state of charge of the battery is at least about 80%. Typically, the current and power are decreased while the voltage level is maintained.

The voltage regulation that can be used by the voltage control mode in the present system is described in greater detail in U.S. Pat. No. 11,770,084, titled VOLTAGE REGULATION OF HIGH VOLTAGE DIRECT CURRENT SYSTEMS, the disclosure of which is hereby incorporated by reference.

The regulation of power and current that can be used by the power control mode in the present system is described in greater detail in U.S. Patent Application Publication No. 2024/0072566, titled ENERGY MANAGEMENT OF HYBRID ELECTRICAL SYSTEMS, the disclosure of which is hereby incorporated by reference.

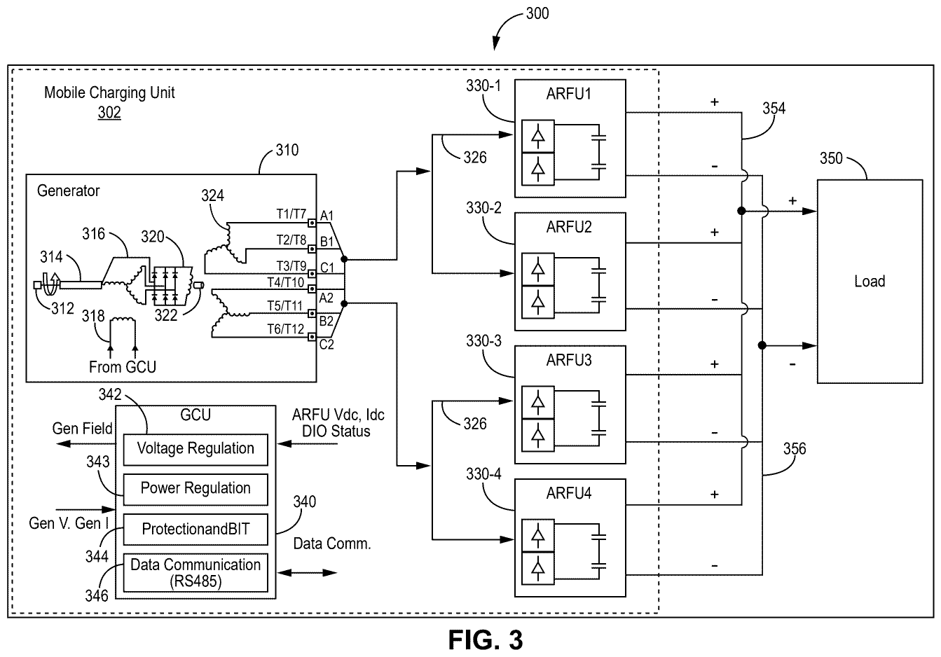

FIG. 3 is a schematic diagram of a system 300 for fast charging a battery of an electric vehicle, according to another embodiment. The system 300 is implemented in a mobile charging unit 302, and includes a generator 310, such as 1,000 kW generator. The generator 310 can generate six-phase or other number of a multi-phase AC electrical power output. The generator 310 includes a rotor 312 coupled to a drive shaft 314 that rotates an exciter rotor 316 in relation to an exciter stator 318. The exciter rotor 316 may generate three-phase AC electrical power provided to a rectifier assembly 320 that includes rotating diodes. The rectifier assembly 320 provides DC electrical power for driving a generator rotor 322 that rotates in relation to a generator stator 324. The generator stator 324 provides AC power as an output of the generator 310, which is directed to a set of bus bars 326 (e.g., 24 flexible bus bars).

A set of power converters 330-1 to 330-4 are operative to receive the AC power from the generator 310 through the bus bars 326 and convert the AC power output to HVDC power. The power converters 330-1 to 330-4 can be advanced rectifiers filter units (ARFUs).

A generator control unit (GCU) 340 is operatively coupled to the generator 310 and the power converters 330-1 to 330-4. The generator control unit 340 is configured to selectively regulate the HVDC power output from the power converters 330-1 to 330-4. The generator control unit 340 is also configured to selectively regulate the power and current of the power converters 330-1 to 330-4. The generator control unit 340 provides a voltage regulation module 342, a power regulation module 343, a protection and BIT (built-in-test) module 344, and a data communication module 346. The generator control unit 340 can be a HVDC connected generator control unit (GCU).

In some embodiments, the generator 310 provides measurements of an AC voltage and an AC current to the generator control unit 340, which can function as an AC voltage regulator. The generator control unit 340 may also provide an excitation field to the exciter stator 318 to control the operation of the exciter rotor 316.

The system 300 provides the HVDC power output from the power converters 330-1 to 330-4 to a load 350 that in one embodiment can be a battery, such as through a set of bus bars 354, 356.

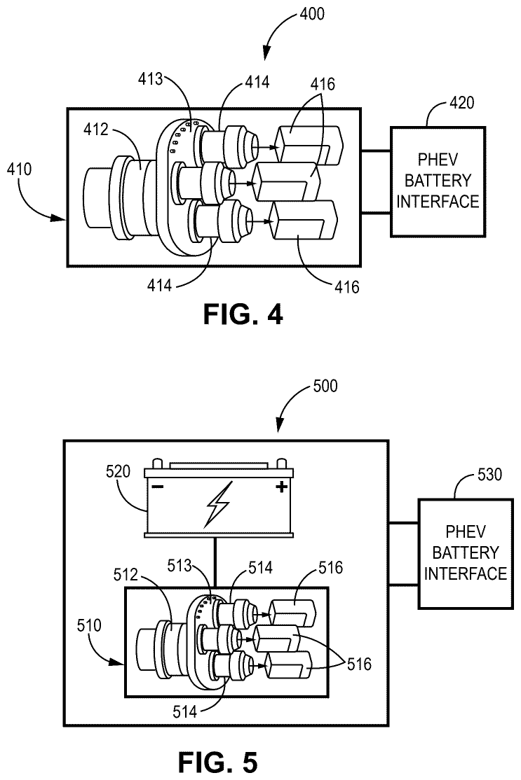

FIG. 4 illustrates a fast charging system 400 using compact power generation, according to one implementation. The system 400 provides a compact low-weight, mobile fast charger having a turbogenerator 410 having a HVDC output. The turbogenerator 410 includes a turbine 412 coupled via a speed decreaser gearbox 413 to a set of generators 414, such as 250 kW generators. A set of power converters 416 are operative to receive AC power from the generators 414 and convert the AC power to HVDC power. The power converters 416 can be advanced rectifier filter units. A PHEV battery interface 420 is configured to be coupled to provide the HVDC power output from the fast charging system 400 to a battery of an electric vehicle.

FIG. 5 illustrates a fast charging system 500 using compact power generation, according to another implementation. The system 500 provides a compact mobile fast charger combined with energy storage for increased capacity. The system 500 includes a turbogenerator 510 having a HVDC output, which is coupled to a battery storage system 520 for storing electrical power. The turbogenerator 510 includes a turbine 512 coupled via a speed decreaser gearbox 513 to a set of generators 514, such as 250 kW generators. A set of power converters 516 are operative to receive AC power from the generators 514 and convert the AC power to HVDC power. The power converters 516 can be advanced rectifier filter units. A PHEV battery interface 530 is configured to be coupled to provide the HVDC power output from the fast charging system 500 to a battery of an electric vehicle. The available HVDC power for charging can be provided by the output of turbogenerator 510, or by the battery storage system 520.

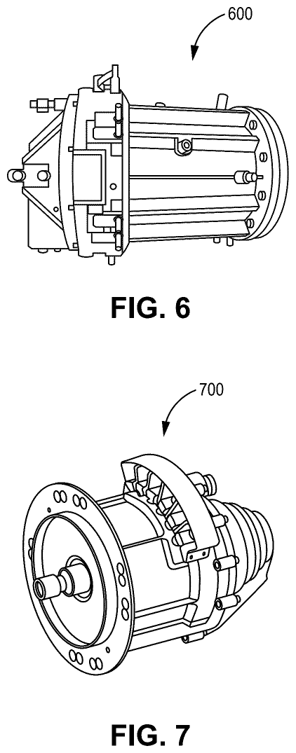

FIG. 6 illustrates a 1,000 kW generator 600 that can be used in the present fast charging systems. The generator 600 provides high power density and high efficiency in a compact design, with a lower weight (e.g., less than about 150 kg).

FIG. 7 illustrates a 250 kW generator 700 that can be used in the present fast charging systems. The generator 700 provides high power density and high efficiency in a compact design, with an even lower weight (e.g., less than about 40 kg).

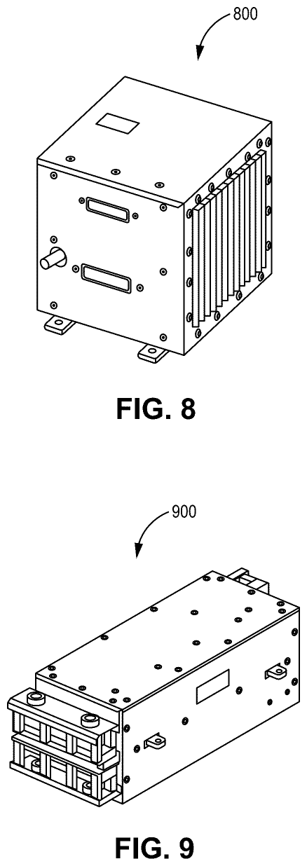

FIG. 8 illustrates a high voltage DC generator control unit 800 that can be used in the present fast charging systems. The generator control unit 800 can be used in charging systems that have a DC output of up to about 1000 VDC. Higher voltages of up to about 1,500 VDC can be used as well.

FIG. 9 illustrates an advanced rectifier filter unit 900 that can be used in the present fast charging systems. The advanced rectifier filter unit 900 can be used in charging systems that have a DC output of up to about 1000 VDC.

In one example, a fast charging system can employ a single 1,000 kW generator, such as the generator 600 (FIG. 6), a single high voltage DC connected generator control unit, such as the generator control unit 800 (FIG. 8), and four advanced rectifier filter units, such as four of the advanced rectifier filter unit 900 (FIG. 9).

In another example, a fast charging system can employ a single 250 kW generator, such as the generator 700 (FIG. 7), a single high voltage DC connected generator control unit, such as the generator control unit 800, and a single advanced rectification filter unit, such as the advanced rectifier filter unit 900.

### Example Embodiments

Example 1 includes a charging system, comprising: a prime mover; a gear box operatively coupled to the prime mover; at least one generator operatively coupled to the gear box, the at least one generator configured to produce an alternating current (AC) output with a frequency of at least about 300 Hz; at least one power converter operatively coupled to the at least one generator, the at least one power converter configured to convert the AC output to a high voltage direct current (HVDC) power output of at least about 50 kW; a generator control unit operatively coupled to the at least one generator and the at least one power converter, the generator control unit configured to: selectively regulate a voltage of the HVDC power output from the at least one power converter, in one of a plurality of modes; and selectively regulate a power of the at least one power converter, in another of the plurality of modes; and at least one interface configured to be coupled to provide the HVDC power, output from the at least one power converter, to a battery of at least one electric vehicle.

Example 2 includes the charging system of Example 1, wherein the prime mover comprises a turbine, a diesel engine, or a Wankel engine.

Example 3 includes the charging system of any of Examples 1-2, wherein the at least one generator comprises a high speed generator.

Example 4 includes the charging system of any of Examples 1-3, wherein the at least one power converter comprises at least one rectifier.

Example 5 includes the charging system of any of Examples 1-4, wherein the generator control unit is configured to selectively regulate a voltage of the HVDC power output.

Example 6 includes the charging system of any of Examples 1-5, wherein the generator control unit is configured to selectively control the HVDC output of the at least one generator using AC voltage regulation, and using DC voltage regulation.

Example 7 includes the charging system of any of Examples 1-6, wherein the generator control unit is configured to selectively regulate a power of the at least one power converter based on a parameter of the battery of an electric vehicle.

Example 8 includes the charging system of any of Examples 1-7, wherein the generator control unit is configured to increase or decrease an excitation current to the at least one generator.

Example 9 includes the charging system of any of Examples 1-8, wherein the charging system is implemented in a mobile charging unit.

Example 10 includes the charging system of any of Examples 1-9, wherein the at least one generator is a 50 kW generator.

Example 11 includes the charging system of any of Examples 1-9, wherein the at least one generator is a 1,000 kW generator.

Example 12 includes the charging system of any of Examples 1-11, further comprising a battery storage system for storing electrical power and configured to receive the HVDC power output.

Example 13 includes the charging system of Example 12, wherein the at least one interface is configured to be coupled to the battery storage system to provide HVDC power to a battery of at least one electric vehicle.

Example 14 includes a system for charging a battery for an electric vehicle, the system comprising: a generator configured to produce a multi-phase alternating current (AC) power output; a set of power converters operatively coupled to the generator, the power converters configured to convert the AC power output to a high voltage direct current (HVDC) power output; and a generator control unit operatively coupled to the generator and the power converters, the generator control unit configured to: selectively regulate the HVDC power output from the power converters, in a voltage control mode; and selectively regulate power and current of the power converters, in a power control mode; wherein the HVDC power output from the power converters is directed to a load through a set of bus bars.

Example 15 includes the charging system of Example 14, wherein the generator comprises a high speed generator.

Example 16 includes the charging system of any of Examples 14-15, wherein the generator is a 1,000 kW generator.

Example 17 includes the charging system of any of Examples 14-16, wherein the power converters are rectifier filter units.

Example 18 includes the charging system of any of Examples 14-17, wherein the charging system is implemented in a mobile charging unit.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A charging system, comprising:
a prime mover;
a gear box operatively coupled to the prime mover;
at least one generator operatively coupled to the gear box, the at least one generator configured to produce an alternating current (AC) output with a frequency of at least about 300 Hz;
at least one power converter operatively coupled to the at least one generator, the at least one power converter configured to convert the AC output to a high voltage direct current (HVDC) power output of at least about 50 kW;
a generator control unit operatively coupled to the at least one generator and the at least one power converter, the generator control unit configured to:
selectively regulate a voltage of the HVDC power output from the at least one power converter, in one of a plurality of modes; and
selectively regulate a power of the at least one power converter, in another of the plurality of modes; and
at least one interface configured to be coupled to provide the HVDC power, output from the at least one power converter, to a battery of at least one electric vehicle.

2. The charging system of claim 1, wherein the prime mover comprises a turbine, a diesel engine, or a Wankel engine.

3. The charging system of claim 1, wherein the at least one generator comprises a high speed generator.

4. The charging system of claim 1, wherein the at least one power converter comprises at least one rectifier.

5. The charging system of claim 1, wherein the generator control unit is configured to selectively regulate a voltage of the HVDC power output.

6. The charging system of claim 1, wherein the generator control unit is configured to selectively control the HVDC output of the at least one generator using AC voltage regulation, and using DC voltage regulation.

7. The charging system of claim 1, wherein the generator control unit is configured to selectively regulate a power of the at least one power converter based on a parameter of the battery of an electric vehicle.

8. The charging system of claim 1, wherein the generator control unit is configured to increase or decrease an excitation current to the at least one generator.

9. The charging system of claim 1, wherein the charging system is implemented in a mobile charging unit.

10. The charging system of claim 1, wherein the at least one generator is a 50 kW generator.

11. The charging system of claim 1, wherein the at least one generator is a 1,000 kW generator.

12. The charging system of claim 1, further comprising a battery storage system for storing electrical power and configured to receive the HVDC power output.

13. The charging system of claim 12, wherein the at least one interface is configured to be coupled to the battery storage system to provide HVDC power to a battery of at least one electric vehicle.

14. A system for charging a battery for an electric vehicle, the system comprising:
a generator configured to produce a multi-phase alternating current (AC) power output;
a set of power converters operatively coupled to the generator, the power converters configured to convert the AC power output to a high voltage direct current (HVDC) power output; and
a generator control unit operatively coupled to the generator and the power converters, the generator control unit configured to:
selectively regulate the HVDC power output from the power converters, in a voltage control mode; and
selectively regulate power and current of the power converters, in a power control mode;
wherein the HVDC power output from the power converters is directed to a load through a set of bus bars.

15. The charging system of claim 14, wherein the generator comprises a high speed generator.

16. The charging system of claim 14, wherein the generator is a 1,000 kW generator.

17. The charging system of claim 14, wherein the power converters are rectifier filter units.

18. The charging system of claim 14, wherein the charging system is implemented in a mobile charging unit.
